(19) United States
(12) Patent Application Publication
(10) Pub. No.: US 2009/0175195 A1
(43) Pub. Date: Jul. 9, 2009

(54) METHODS, SYSTEMS AND COMPUTER PROGRAM PRODUCTS FOR USING TIME DOMAIN REFLECTOMETRY SIGNATURES TO MONITOR NETWORK COMMUNICATION LINES

(75) Inventor: Daniel Warren Macauley, Fishers, IN (US)

Correspondence Address: MYERS BIGEL SIBLEY & SAJOVEC, P.O. BOX 37428, RALEIGH, NC, 27612, US

(73) Assignee: CommScope, Inc. North Carolina

(21) Appl. No.: 11/970,083

(22) Filed: Jan. 7, 2008

(51) Int. Cl. H04L 12/28

(52) U.S. Cl. 370/254

(57) ABSTRACT

Methods, systems and computer program products for uniquely identifying communication lines in a network via time domain reflectometry (TDR) signatures are provided. A pulsed signal is sent into a communication line through a patch panel connector port and a reflection of the pulsed signal through the patch panel connector port is received to obtain a TDR signature for each communication line. The pulsed signal is sent and received by a controller operatively associated with the patch panel and/or by a network switch in communication with the patch panel. Connection changes and/or communication line faults at a network patch panel are detected by comparing current and stored TDR signatures.

### FIELD OF THE INVENTION

The present invention relates generally to networks and, more particularly, to network patching systems.

### BACKGROUND OF THE INVENTION

Many businesses, government agencies, education establishments, and other organizations have dedicated networks that enable computers, telephones, facsimile machines and the like to communicate with each other, and to communicate with devices in remote locations via a communications service provider. Conventionally, a dedicated network is hard wired using communication lines that contain conductive wires. In such hard wired systems, dedicated wires are coupled to individual service ports throughout a building, for example. The wires from the dedicated service ports conventionally extend throughout a building and into one or more closets. The communication lines from the interface hub of a main frame computer, network server or the like and the communication lines from external communication service providers may also terminate within a closet or computer room.

A network patching system is typically used to interconnect the various communication lines within a closet or computer room. In a conventional network patching system, the communication lines are terminated in an organized manner via one or more patch panels. For example, referring to FIG. 1, a typical patch panel support rack 10 is shown. The rack 10 retains a plurality of patch panels 12 that are mounted to the rack 10. On each of the patch panels 12 are located port assemblies 14. The illustrated port assemblies 14 each contain communication connector ports 16 (e.g., RJ-45 ports, RJ-11 ports, etc.). Other types of patch panels are known, including patch panels with optical fiber ports (e.g., SC, ST and LC ports) and 110-style copper wire ports.

Each of the different communication connector ports 16 is hard wired to a communication line. It will be understood that a “communication line” may comprise multiple wires. For example, a conventional “communication line” to an RJ-45 connector port comprises four differential wire pairs or a total of eight copper wires. The term “communication line” as used herein means, for example, the structured wiring from a patch panel connector (16, FIG. 2) to a particular device or jack connected to the LAN.

Each communication line is terminated on a patch panel 12 in an organized manner. In small patch systems, all communication lines may terminate on the patch panels of the same rack. In larger patch systems, multiple racks may be used, wherein different communication lines terminate on different racks. Interconnections between the various communication lines are made using patch cords 20. Both ends of a patch cord 20 are terminated with connectors 22, such as an RJ-45 or RJ-11 or 110-style communication connector. One end of a patch cord 20 is connected to a connector port 16 of a first communication line and the opposite end of the patch cord 20 is connected to a connector port 16 of a second communication line. By selectively connecting the various communication lines with patch cords 20, any combination of communication lines can be interconnected.

In many businesses, employees are assigned their own computer network access number exchange so that the employee can interface with a main frame computer or computer network. When an employee changes office locations, it may not be desirable to provide that employee with new exchange numbers. Rather, to preserve consistency in communications, it may be preferred that the exchanges of the communication ports in the employee's old office be transferred to the communication ports in the employee's new office. To accomplish this task, patch cords in a communication closet are rearranged so that the employee's old exchanges are now received in his/her new office.

As employees are added, leave, move, and/or change positions, and/or as the business adds or subtract communication lines, the patch cords in a typical closet may require frequent rearrangement. Network patching systems that have the ability to sense a plug in a patch panel port or sense connection between two patch panel ports are referred to as intelligent patching systems. Intelligent patching systems are described in U.S. Pat. No. 6,222,908, which is incorporated herein by reference in its entirety.

It may take a significant amount of time for a technician to manually trace a particular patch cord, particularly within a collection of other patch cords. Furthermore, manual tracing may not be completely accurate and technicians may accidentally go from one patch cord to another during a manual trace. Such errors may result in misconnected telecommunication lines which must be later identified and corrected. Also, it may be difficult to identify the correct port to which a particular patch cord end should be connected or disconnected. Thus, ensuring that the proper connections are made can be very time-consuming, and the process is prone to errors in both the making of connections and in keeping records of the connections. In addition, changes in patch panel connections can be difficult to detect. For example, a patch cord associated with a particular communication line can be inserted within other patch panel connector ports and/or network device connector ports without easily being detected.

Accordingly, a need exists for accurately and quickly detecting and identifying patch cord connections and changes thereto in a communications system.

### SUMMARY

In view of the above discussion, methods, systems and computer program products for uniquely identifying communication lines in a network via time domain reflectometry (TDR) signatures are provided. In some embodiments of the present invention, a pulsed signal is transmitted into a communication line through a patch panel connector port and a reflection of the pulsed signal is received through the patch panel connector port to obtain a TDR signature for each communication line. The pulsed signal is sent and received by a controller operatively associated with the patch panel and/or by a network switch in communication with the patch panel.

In some embodiments of the present invention, connection changes at a network patch panel and/or communication line faults are detected by comparing current and stored TDR signatures. A TDR test is executed on a communication line to obtain a current TDR signature for a respective communication line, and the current TDR signature is compared with a stored TDR signature for the communication line. A connection change to a communication line and/or a communication line fault is identified in response to determining that a current TDR signature is different from a stored TDR signature. The TDR test is performed by a controller operatively associated with the patch panel and/or a network switch or other device in communication with the patch panel. A connection change includes connecting a communication line to other patch panel connector ports or other devices via a patch cord. A communication line fault may include anything associated with a communication line that does not meet transmission guidelines or tolerances.

In some embodiments, a patch panel connector port is parked (i.e., disabled) immediately upon detection of a connection change to a communication line associated therewith and/or upon detection of a communication line fault. A work order may be generated that directs a technician to address the connection change and/or fault. In some embodiments, a patch panel connector port is parked after determining that a detected connection change is not an authorized change. In some embodiments, an administrator (or other technical person) is notified when a current TDR signature is different from a stored, previous TDR signature for a communication line (i.e., when a connection change is detected).

In some embodiments, a current TDR signature can be used to identify a connection path for a communication line. For example, a TDR signature can be used to identify where a communication line is connected via one or more patch cords on a patch panel, other devices, etc.

### BRIEF DESCRIPTION OF THE DRAWINGS

FIG. 1 is a perspective view of a typical prior art network rack assembly containing multiple patch panels with connector ports that are selectively interconnected by patch cords.

FIG. 2 is a perspective view of a network patching system rack assembly that includes a plurality of patch panels, a tracing interface module, and a controller configured to implement embodiments of the present invention.

FIGS. 3-4 are flowcharts of operations for creating TDR signatures for respective communication lines in a network, and for detecting connection changes and/or communication line faults at network patch panels based on a comparison of current TDR signatures and stored TDR signatures for communication lines, in accordance with various embodiments of the present invention.

FIG. 5 is a block diagram that illustrates an architecture for creating TDR signatures for respective communication lines in a network and for detecting connection changes and/or communication line faults at a network patch panel based on a comparison of current TDR signatures and stored TDR signatures for communication lines, in accordance with some embodiments of the present invention.

### DETAILED DESCRIPTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first communication line could be termed a second communication line, and, similarly, a second communication line could be termed a first communication line without departing from the teachings of the disclosure.

As used herein, the term “communication line fault” is inclusive of all problems associated with a communication line that cause the communication line to not meet quality of service requirements and/or to not meet specifications or standards that the communications line is supposed to meet. Thus, a fault includes physical connection problems, electrical transmission problems, and the like, associated with a communication line.

The present invention may be embodied as systems, methods, and/or computer program products for uniquely identifying communication lines in a network by obtaining individual time domain reflectometry (TDR) signatures for respective communication lines (channels) in the network. The present invention may also be embodied as systems, methods, and/or computer program products for detecting connection changes at a network patch panel based on a comparison of current TDR signatures and stored TDR signatures for communication lines. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain or store the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

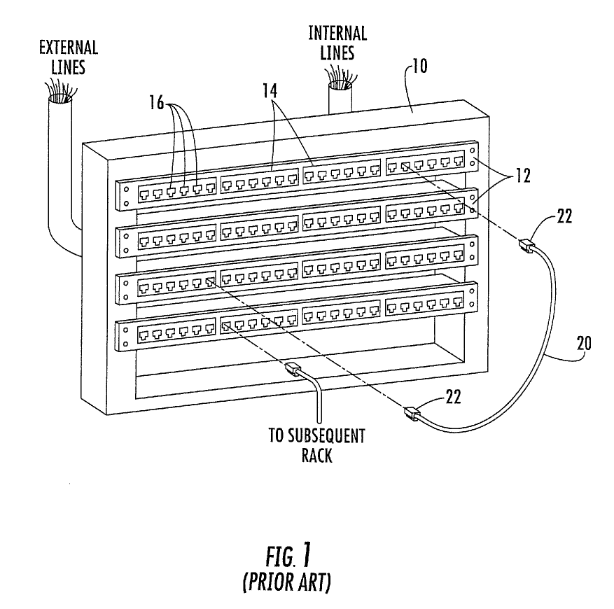

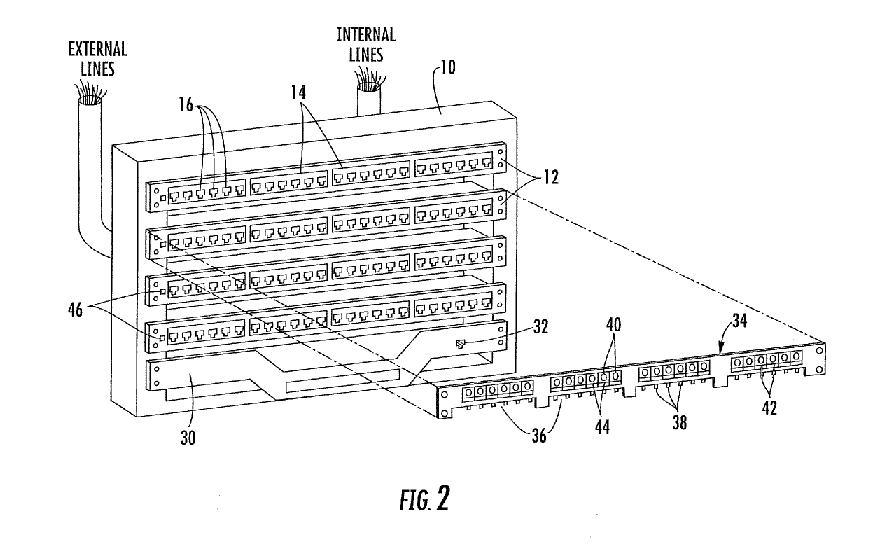

Embodiments of the present invention may be (but are not required to be) utilized with network patching systems that include the capability of detecting patch cord insertions and removals. An exemplary patching system having the capability of detecting patch cord insertions and removals is illustrated in FIG. 2. The illustrated telecommunications rack 10 contains a plurality of patch panels 12, and each of the patch panels 12 contain a plurality of port assemblies 14. The connector ports 16 associated with each of the port assemblies 14 are hard wired to incoming external communication lines or incoming internal communication lines, as described above with respect to FIG. 1. Some patch panels 12 may not include port assemblies 14, but instead include a larger number of individual connector ports 16. A rack controller 30 is mounted to, or otherwise associated with, each rack 10. It will be appreciated that a single rack controller 30 may be associated with multiple racks 10. The rack controller 30 contains a central processing unit (CPU) that may be configured to implement embodiments of the present invention.

In the illustrated embodiment, a tracing interface module 34 mounts, for example, to the face of each patch panel 12 on the rack 10. The tracing interface modules 34 surround the various connector ports 16 located on patch panels 12 and provide an interface through which data about each connector port 16 can be transmitted to and from the rack controller 30. A tracing interface module 34 may have any of various configurations and may even be built into a patch panel (i.e., need not be an externally mounted apparatus on a patch panel).

The illustrated tracing interface module 34 includes a plurality of sensors 38, wherein each sensor 38 corresponds in position with one of the connector ports 16 on the patch panel 12. As the terminated end of a patch cord 20 (FIG. 1) is connected to, or removed from, a connector port 16, the presence or absence of the patch cord is detected by the rack controller 30 via a respective sensor 38, as would be understood by one skilled in the art of the present invention. The rack controller 30 is therefore capable of automatically determining when a patch cord has been added or removed from any connector port 16 on the rack 10.

In addition to the sensors 38, the illustrated tracing interface module 34 includes light emitting diodes (LEDs) 40 and tracing buttons 44. An LED 40 and tracing button 44 are provided for each connector port 16 when the tracing interface module 34 is connected to the patch panel 12. Accordingly, each connector port 16 on the patch panel 12 has an LED 40 and tracing button 44 that corresponds in position to that connector port 16. The rack controller 30 may be connected to all the LEDs 40, trace buttons 44 and sensors 38 on all of the trace interface modules 34.

When a patch cord 20 (FIG. 1) is placed into any connector port 16 (FIG. 2), or removed from any connector port 16, that change is sensed by a sensor 38 and is communicated to the rack controller 30. The rack controller 30 is therefore capable of monitoring any and all changes that occur with respect to the patch cords in the patch system over time. The rack controller 30 may also be configured to automatically keep an accurate log of all changes that have occurred with respect to the patch cords since the installation of the system. Accordingly, if a technician is servicing the patch system, that technician can read the accurate log straight from the rack controller 30.

In addition to keeping an accurate log of all physical patch cord changes, the end points of any patch cord 20 (FIG. 1) can be accurately traced. For instance, suppose a technician wants to find the opposite end of a particular patch cord. That technician can press the trace button 44 that corresponds in position to the known end of the patch cord. Upon the pressing of the trace button 44, the rack controller 30 will review its log and determine where the opposite end of that patch cord is located. The rack controller 30 will then light the LED 40 that corresponds in position to the opposite end of the targeted patch cord. The technician then need only look for the lit LED 40 on one of the tracing interface modules 34 to find the opposite end of the targeted patch cord.

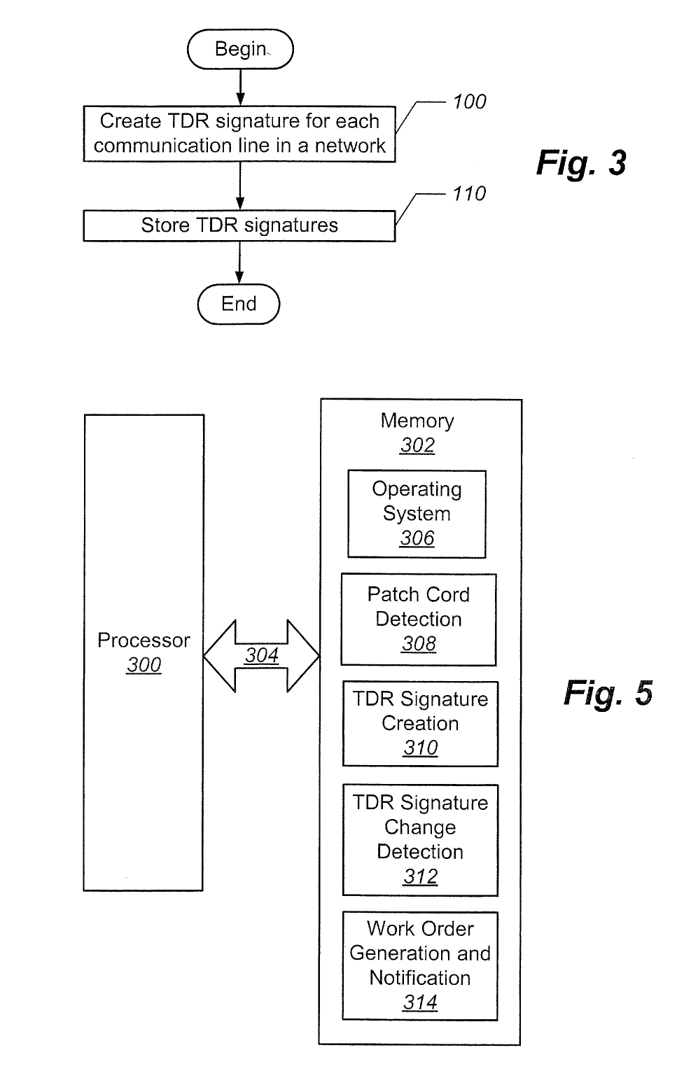

According to embodiments of the present invention, the rack controller 30 may also be configured to uniquely identify communication lines in a network by obtaining individual time domain reflectometry (TDR) signatures for respective communication lines in the network. The rack controller 30 may also be configured to detect connection changes and/or communication line faults at a network patch panel by executing TDR tests on communication lines to obtain current TDR signatures for each communication line, and comparing current TDR signatures with stored TDR signatures for the communication lines, as will be described below with respect to FIGS. 3-5.

Referring to FIG. 3, TDR signatures are obtained for each communication line in a network (Block 100), such as a local area network (LAN), and stored, for example, in a database (Block 110). As would be understood by those skilled in the art, a LAN is a system of personal computers, work stations, terminals and/or devices that are interconnected via a building's structured voice and/or data wiring to form a network that permits groups of people to work together. Each communication line, because of its physical layout, geometry, electrical and other characteristics, etc. is unique and can be uniquely identified by a respective TDR signature.

A TDR signature is obtained by sending a signal (e.g., a pulsed signal, non-pulsed signal, etc.) into a respective communication line through a patch panel connector port (16, FIG. 2) and receiving a reflection of the signal through the patch panel connector port (16, FIG. 2). Operations for obtaining individual TDR signatures can be performed by a controller operatively associated with a patch panel and/or by a network switch (or other device) in communication with a patch panel. For example, such a controller may be part of the rack controller 30.

TDR signatures can be obtained, for example, shortly after the structured wiring of a building is installed. However, TDR signatures can be obtained for communication lines in a network at any time. The object is to obtain “baseline” TDR signatures that can be compared with subsequently-obtained TDR signatures for the purpose of detecting connection changes and/or communication line faults. Each communication line will have a unique TDR signature because the length and physical route of each communication line is unique.

The use of TDR to assist with determining communication line changes and faults is based on two approaches. The first approach uses the distance number to calculate the distance of a communication line. A network system according to embodiments of the present invention constantly updates this number as patches are added and removed from the system. The network system can use this number to determine the length of a communication line and monitor the communication line for changes in the length of the communication line. If the changes are associated with patching changes detected by an intelligent patching system, the network system can update the communication line number to reflect the patching changes in the communication line. If the length of the communication line changes without a detected patching change, the network system can either flag the change as a potential fault and provide the location of the fault or as a patching/cabling change that is not monitored by an intelligent patching system. The triggers for this can include: 1) the amount of distance changed; 2) whether the distance increased or decreased; and 3) whether the distance goes to zero indicating a patch cord was removed from a switch.

A network system, according to embodiments of the present invention, can be enhanced by loading test data from certification testing performed on the cabling. This would give the network system the lengths of the cabling between panel ports and between a jack and a panel port. Embodiments of the present invention are particularly effective when combined with the ability to detect patch panel changes, and can be implemented with the use of switches that have the ability to measure the distance of communication lines using TDR.

When TDR is run on a communication line, there are a series of peaks that indicate additional reflections in the communication line. These reflections may be caused by a variety of imperfections in the communication line including, but not limited to, the patch cords, the idc connections on the back of a panel or jack, imperfections in the cabling, etc. This can also be used to determine potential faults in the cabling infrastructure caused by work being done in a communications closet to loosen connections or by bad workmanship.

Embodiments of the present invention enhance intelligent patching systems by looking at the position and amplitudes of TDR reflections. This information can be stored in a raw form or as a scalar that provides a unique identification for a communication line. With sufficient resolution, a network system should be able to create unique signatures for each communication line in a network and detect even subtle changes such as a patch cord be moved from one switch port to another. A network system according to embodiments of the present invention also provides the ability to alert users of changes without the use of intelligent patch panels.

Embodiments of the present invention will now be described herein with reference to flowchart and/or block diagram illustrations of methods, systems, and computer program products for uniquely identifying communication lines in a network by obtaining individual TDR signatures for respective communication lines in the network, and for detecting connection changes and/or communication line faults at a network patch panel based on comparisons of current and stored TDR signatures in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions are provided to a processor of a patch panel rack controller, or other programmable data processing apparatus associated with a patch panel system, to produce a machine, such that the instructions, which execute via the processor and create means for implementing the functions specified in the flowchart and/or block diagram block or blocks.

These computer program instructions may also be stored in a computer usable or computer-readable memory that may direct a patch panel system controller and/or network switch (or other device) to function in a particular manner, such that the instructions stored in the computer usable or computer-readable memory produce an article of manufacture including instructions that implement the function specified in the flowchart and/or block diagram block or blocks.

The computer program instructions may also be loaded onto a patch panel system controller and/or network switch or other programmable data processing apparatus to cause a series of operational steps to be performed on the controller or other programmable apparatus to produce a computer implemented process such that the instructions that execute on the controller, network switch or other programmable apparatus provide steps for implementing the functions specified in the flowchart and/or block diagram block or blocks.

The flowcharts of FIGS. 3-4 illustrate the architecture, functionality, and operations of embodiments of methods, systems, and computer program products for uniquely identifying communication lines in a network by obtaining individual TDR signatures for respective communication lines in the network, and in detecting connection changes and/or communication line faults at a network patch panel based on comparisons of current and stored TDR signatures. In this regard, each block in the flowcharts may represent a module, segment, or portion of code, which comprises one or more executable instructions for implementing the specified logical function(s). It should also be noted that in other implementations, the function(s) noted in the blocks may occur out of the order described with respect to FIGS. 3-4. For example, the step of identifying a new communication path (Block 265) may occur prior to determining if a connection change that resulted in the new path is authorized (Block 260). Moreover, one or more blocks in the flowcharts illustrated in FIGS. 3-4 may occur independently of other blocks.

Referring to FIG. 4, operations for monitoring a network at a network patch panel utilizing TDR signatures, according to embodiments of the present invention, are illustrated. A TDR test is executed on each communication line to obtain a current TDR signature for that communication line (Block 200). The current TDR signature is compared with a stored TDR signature for the communication line (Block 210). A determination is made whether the current TDR signature differs from the stored TDR signature (Block 220).

If the answer is yes, then a connection change has been made and/or there is a fault in the communication line. It is then determined whether a connection change has occurred and/or whether a communication line fault exists (Block 230). If the answer is no, operations continue for another communication line (i.e., a TDR test is executed on the next communication line to obtain a current TDR signature for that communication line (Block 200)).

A current TDR signature is obtained as described above with respect to obtaining baseline TDR signatures. For example, a patch panel controller or network switch in communication with a patch panel obtains a TDR signature by sending a pulsed signal into a respective communication line through a patch panel connector port (16, FIG. 2) and receiving a reflection of the pulsed signal through the patch panel connector port (16, FIG. 2).

If a connection change has been identified (Block 250), a determination is then made whether the connection change is an authorized connection change (Block 260). If the connection change is unauthorized, a patch panel connector port (16, FIG. 2) associated with the communication line is “parked” (Block 270). The term “parked” means that a connector port is essentially disabled and cannot be used to access one or more network services without authorization. Port parking is an advantageous security feature of embodiments of the present invention because it can occur automatically without intervention by an administrator or technician (i.e., the controller 30 and/or network switch or other device can automatically park a port).

According to some embodiments of the present invention, detection of an unauthorized connection change may cause the generation of a work order (Block 275). As is known to those skilled in the art of the present invention, a work order is a list of activities to be performed by a technician on a network. According to embodiments of the present invention, a work order may include instructions to return an unauthorized connection to a previous, authorized state. Exemplary work order activities may include, but are not limited to, port configuration, installing network equipment, installing patch panels, installing outlets, cabling outlets to panels, adding/removing/moving patch cords, adding/removing/moving devices such as computers and phones, making changes to a communication/data network on passive connecting hardware (e.g., connecting hardware, consolidation points, panels, etc.).

According to some embodiments of the present invention, an administrator (or technician) may be notified that a connection change is unauthorized (Block 280). Notification may be accomplished in any of various ways. For example, an electronic message can be transmitted to a user and/or an administrator via cell phone, pager, wrist watch, PDA, computer, etc. Notification can occur immediately upon the detection of a connection change or can be occur later in time.

According to some embodiments of the present invention, an administrator (or technician) may be notified automatically upon determining that a current TDR signature is different (Block 220). Notification, thus, may occur automatically without requiring a determination if, for example, a connection change is authorized.

According to some embodiments of the present invention, a patch panel connector port associated with a communication line may be parked immediately upon detection of a change in TDR signatures, without determining, for example, if a connection change is authorized or not. Moreover, a work order may be generated (Block 275) and/or an administrator notified (Block 280) without determining, for example, if a connection change is authorized or not.

According to some embodiments of the present invention, a new communication path resulting from an authorized connection change is identified (Block 265). In other words, the path from a patch panel connector port for a communication line to another patch panel connector port or network device port (i.e., via a patch cord) is identified. However, embodiments of the present invention are not limited to identification of communication paths for authorized connections. Path identification may be performed regardless of whether a connection change is authorized or not.

If a communication line fault has been identified (Block 240), a patch panel connector port (16, FIG. 2) associated with the communication line may be parked (Block 270), a work order may be generated (Block 275) and/or an administrator (or technician) may be notified (Block 280).

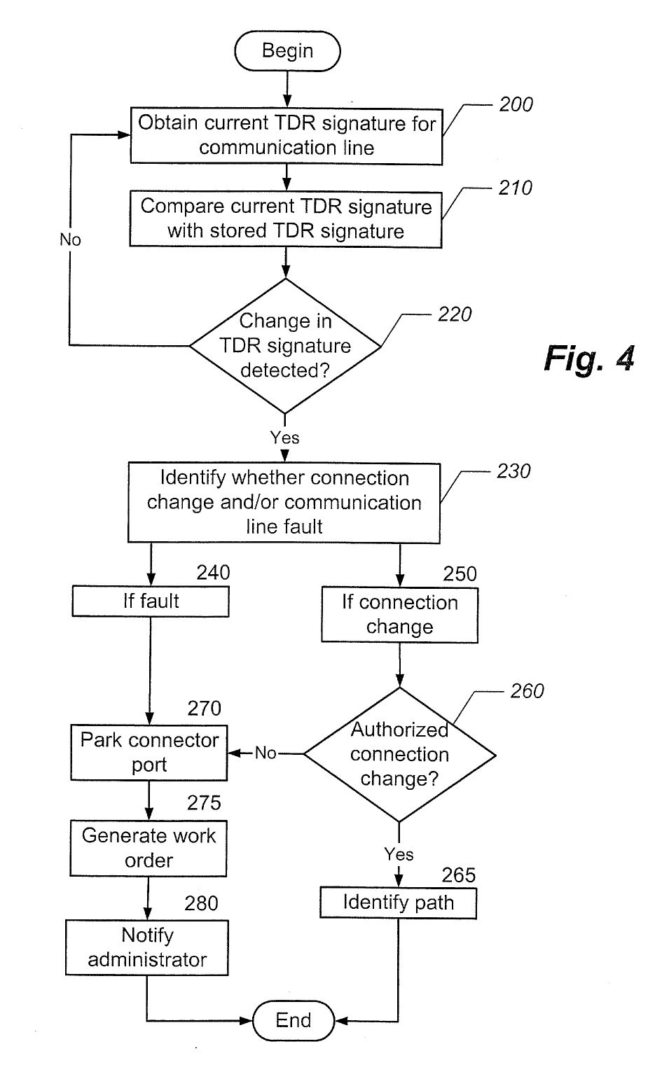

FIG. 5 illustrates a processor 300 and a memory 302 hosted by the rack controller 30 or a network switch (or other device) that may be used in embodiments of methods, systems, and computer program products for monitoring a network, according to the present invention. For example, in some embodiments of the present invention, the processor 300 and memory 302 may be used to embody the processors and the memories used in uniquely identifying communication lines in a network by obtaining individual TDR signatures for respective communication lines in the network, and in detecting connection changes and/or communication line faults at a network patch panel based on comparisons of current and stored TDR signatures.

The illustrated processor 300 communicates with the memory 302 via an address/data bus 304. The processor 300 may be, for example, a commercially available or custom microprocessor. The memory 302 is representative of the overall hierarchy of memory devices containing the software and data used to obtain individual TDR signatures for respective communication lines in a network, and to detect connection changes and/or communication line faults at a network patch panel based on comparisons of current and stored TDR signatures, in accordance with some embodiments of the present invention. The memory 302 may include, but is not limited to, the following types of devices: cache, ROM, PROM, EPROM, EEPROM, flash, SRAM, and DRAM.

As shown in FIG. 5, the memory 302 may hold various categories of software and data: an operating system 306, a patch cord detection module 308, a TDR signature creation module 310, a TDR signature change detection module 312, and a work order generation and notification module 314. The operating system 306 controls operations of the rack controller 30 (or network switch or other device). In particular, the operating system 306 may manage the rack controller's resources and may coordinate execution of programs by the processor 300.

The patch cord detection module 308 comprises logic for detecting patch cord insertions and removals from connector ports 16 in the patch panels 12 as well as connector ports in network devices. In some embodiments, the patch cord detection module 308 comprises logic for parking switch connector ports when connection changes are identified (e.g., when it is detected that a patch cord has been inserted in and/or removed from a patch panel connector port for a communication line).

The TDR signature creation module 310 comprises logic for obtaining TDR signatures for each communication line in a network and for storing these TDR signatures as “baseline” signatures, for example, in a database. The TDR signature creation module 310 comprises logic for sending a pulsed signal into a respective communication line through a patch panel connector port (16, FIG. 2) and receiving a reflection of the pulsed signal through the patch panel connector port (16, FIG. 2).

The TDR signature change detection module 312 comprises logic for detecting connection changes and/or communication line faults at a network patch panel utilizing TDR signatures. For example, the TDR signature change detection module 312 comprises logic for executing a TDR test on each communication line to obtain a current TDR signature for that communication line, for comparing the current TDR signature with a stored TDR signature for the communication line, and for determining whether the current TDR signature differs from the stored TDR signature. The TDR signature change detection module 312 also comprises logic for identifying a connection path of a communication line (i.e., the path from a patch panel connector port for the communication line to another patch panel connector port or network device port via a patch cord).

In some embodiments, the TDR signature change detection module 312 comprises logic for determining if a detected connection change is authorized. In some embodiments, the TDR signature change detection module 312 comprises logic for notifying an administrator (or other technician/person) that a connection change has been detected, whether authorized or not.

The work order generation and notification module 314 comprises logic for generating work orders to return an unauthorized connection to a previous, authorized state or to perform some other function with respect to changed connections. In some embodiments, the work order generation and notification module 314 comprises logic for notifying a technician or technician group upon the generation of a work order.

Although FIG. 5 illustrates an exemplary software architecture that may facilitate uniquely identifying communication lines in a network by obtaining individual TDR signatures for respective communication lines in the network, and detecting connection changes and/or communication line faults at a network patch panel based on comparisons of current and stored TDR signatures, it will be understood that the present invention is not limited to such a configuration but is intended to encompass any configuration capable of carrying out the operations described herein. Embodiments of the present invention can be integrated into management software utilized by intelligent patching systems.

Computer program code for carrying out operations of the rack controller 30 (or switch or other network device) discussed above with respect to FIGS. 3-5 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. Embodiments of the present invention are not limited to a particular programming language.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method of uniquely identifying communication lines in a network, comprising obtaining individual time domain reflectometry (TDR) signatures for respective communication lines in the network.

2. The method of claim 1, wherein each communication line has one end that terminates at a user connector port and an opposite end that terminates at a patch panel connector port.

3. The method of claim 2, wherein obtaining a TDR signature comprises sending a pulsed signal into a communication line through a patch panel connector port and receiving a reflection of the pulsed signal through the patch panel connector port.

4. The method of claim 2, wherein obtaining individual TDR signatures is performed by a controller operatively associated with the patch panel and/or by a network switch in communication with the patch panel.

5. A method of monitoring a network, wherein the network includes a plurality of communication lines, each communication line having an end that terminates at a respective user connector port and an opposite end that terminates at a respective patch panel connector port, and a plurality of patch cords configured to selectively connect pairs of the patch panel connector ports, the method comprising:
executing a time domain reflectometry (TDR) test on a communication line to obtain a current TDR signature for the communication line;
comparing the current TDR signature with a stored TDR signature for the communication line; and
identifying a connection change to the communication line and/or a fault in the communication line in response to determining that the current TDR signature is different from the stored TDR signature.

6. The method of claim 5, further comprising determining whether an identified connection change is an authorized change.

7. The method of claim 6, further comprising parking a patch panel connector port associated with the communication line and/or generating a work order in response to determining that an identified connection change is not authorized.

8. The method of claim 5, further comprising parking a patch panel connector port associated with the communication line and/or generating a work order in response to identifying a connection change to the communication line and/or a fault in the communication line.

9. The method of claim 5, wherein the TDR test is performed by a controller operatively associated with the patch panel.

10. The method of claim 5, wherein the TDR test is performed by a network switch in communication with the patch panel.

11. The method of claim 5, further comprising notifying an administrator that the current TDR signature is different from the stored TDR signature for the communication line.

12. The method of claim 5, wherein identifying the connection change comprises using the current TDR signature to identify a connection path for the communication line.

13. A network system, comprising:
a patch panel comprising a plurality of connector ports that are connected to respective individual communication lines;
one or more patch cords, each configured to selectively connect respective pairs of patch panel connector ports; and
a network switch operatively associated with the patch panel that is configured to execute a time domain reflectometry (TDR) test on a communication line to obtain a current TDR signature for the communication line, to compare the current TDR signature with a stored TDR signature for the communication line, and to identify a connection change to the communication line and/or a fault in the communication line in response to determining that the current TDR signature is different from the stored TDR signature.

14. The network system of claim 13, wherein the network switch is configured to determine whether the identified connection change is an authorized change.

15. The network system of claim 13, wherein the network switch is configured to park a patch panel connector port associated with the communication line in response to determining that the identified connection change is not authorized.

16. The network system of claim 13, wherein the network switch is configured to park a patch panel connector port associated with the communication line in response to identifying a connection change to the communication line and/or a fault in the communication line.

17. The network system of claim 13, wherein the network switch is configured to use the current TDR signature to identify a connection path for the communication line.

18. A network system, comprising:
a patch panel comprising a plurality of connector ports that are connected to respective individual communication lines;
one or more patch cords, each configured to selectively connect respective pairs of patch panel connector ports; and
a controller operatively associated with the patch panel that is configured to execute a time domain reflectometry (TDR) test on a communication line to obtain a current TDR signature for the communication line, to compare the current TDR signature with a stored TDR signature for the communication line, and to identify a connection change to the communication line and/or a fault in the communication line in response to determining that the current TDR signature is different from the stored TDR signature.

19. The network system of claim 18, wherein the controller is configured to determine whether the identified connection change is an authorized change.

20. The network system of claim 19, wherein the controller is configured to park a patch panel connector port associated with the communication line and/or generate a work order in response to determining that the identified connection change is not authorized.

21. A network system, comprising:
a patch panel comprising a plurality of connector ports that are connected to respective individual communication lines;
a controller operatively associated with the patch panel that is configured to execute a time domain reflectometry (TDR) test on each communication line to obtain a respective TDR signature for each communication line, wherein the controller is configured to obtain a TDR signature for a communication line by sending a pulsed signal into the communication line through a patch panel connector port and receiving a reflection of the pulsed signal through the patch panel connector port; and
a database that stores the TDR signatures.

22. A network system, comprising:
a patch panel comprising a plurality of connector ports that are connected to respective individual communication lines;
a network switch operatively associated with the patch panel that is configured to execute a time domain reflectometry (TDR) test on each communication line to obtain a respective TDR signature for each communication line; and
a database that stores the TDR signatures.

23. The network system of claim 22, wherein the network switch is configured to obtain a TDR signature for a communication line by sending a pulsed signal into the communication line through a patch panel connector port and receiving a reflection of the pulsed signal through the patch panel connector port.

24. A computer program product for uniquely identifying communication lines in a network, comprising:
a computer readable storage medium having computer readable program code embodied therein, the computer readable program code being configured to carry out the method of claim 1.

25. A computer program product for monitoring a network, comprising:
a computer readable storage medium having computer readable program code embodied therein, the computer readable program code being configured to carry out the method of claim 5.
